(19) United States
(12) Patent Application Publication
(10) Pub. No.: US 2022/0112988 A1
(43) Pub. Date: Apr. 14, 2022

(54) HYDROCARBON LEAK DETECTING DEVICES AND METHODS OF DETECTING HYDROCARBON LEAKS

(71) Applicant: Saudi Arabian Oil Company, Dhahran (SA)

(72) Inventor: Yaseen Abduljawad, Dhahran (SA)

(73) Assignee: Saudi Arabian Oil Company, Dhahran (SA)

(21) Appl. No.: 17/065,917

(22) Filed: Oct. 8, 2020

(51) Int. Cl. F17D 5/02; G01M 3/04

(52) U.S. Cl. CPC F17D 5/02; G01M 3/04

(57) ABSTRACT

A hydrocarbon leak detecting device includes a position securing strap, one or more hydrocarbon sensors, and one or more light sources. The position securing strap may include a locking mechanism configured to secure the position securing strap. The one or more hydrocarbon sensors may be positioned along one or more strap faces of the position securing strap. The one or more light sources may be positioned along the one or more strap faces of the position securing strap. The one or more hydrocarbon sensors may be communicatively coupled to the one or more light sources. A method of detecting a hydrocarbon leak may include securing a position securing strap of a hydrocarbon leak detecting device to a test site, performing one or more sensor measurements using the one or more hydrocarbon sensors, and illuminating the one or more light sources based on the one or more sensor measurements.

### BACKGROUND

### Field

The present disclosure generally relates to apparatuses and methods for detecting gas leaks, more specifically, to apparatuses and methods for detecting hydrocarbon gas leaks.

### Technical Background

As hydrocarbons are extracted from a hydrocarbon source, they may be transported to various destinations prior to treatment or processing. During and after treatment or processing, the hydrocarbons may similarly be transported between various pieces of equipment, to different sections of a refinery, or to different storage vessels. The equipment used to transport hydrocarbons between various areas or stations after extraction from the hydrocarbon source may be susceptible to leaks. That is, the equipment may at one time form a fluid-tight seal, but over time may become susceptible to a leak and no longer form a fluid-tight seal. Accordingly, there is a need for improved, efficient methods and devices for detecting hydrocarbon leaks.

### SUMMARY

Detecting hydrocarbon leaks in a timely fashion is of utmost importance in the petroleum industry. As hydrocarbons are extracted from their source, they are transported for treatment and processing. Hydrocarbon leaks, during transport, are costly but are often inevitable as equipment and transport lines wear over time, particularly during continuous use.

Conventional methods of detecting hydrocarbon leaks may require personnel physically inspecting test sites for the presence of a hydrocarbon leak. These conventional methods may require numerous personnel and many hours to inspect all areas that may potentially be susceptible to a hydrocarbon leak. With large test sites, it may be difficult for personnel to monitor the entire test site efficiently. Further, hydrocarbon leak detection may be difficult at night, particularly when continuous detection is desired.

Accordingly, there is an ongoing need for apparatuses and methods for detecting hydrocarbon leaks that are more efficient and effective. The present disclosure is directed to hydrocarbon leak detecting devices and methods of detecting hydrocarbon leaks. These hydrocarbon leak detecting devices may comprise a position securing strap, one or more hydrocarbon sensors and one or more light sources. The hydrocarbon leak detecting devices of the present disclosure are low cost while still increasing the efficiency and accuracy of detecting hydrocarbon leaks. The hydrocarbon leak detecting devices may be able to continuously detect hydrocarbon leaks even during non-daylight hours. The hydrocarbon leak detecting devices may also monitor large test sites without the need for direct personnel exposure to potential hydrocarbon leaks.

According to one or more aspects of the present disclosure, a hydrocarbon leak detecting device may include a position securing strap, one or more hydrocarbon sensors, and one or more light sources. The position securing strap may include a locking mechanism configured to secure the position securing strap to a hydrocarbon test site. The one or more hydrocarbon sensors may be positioned along one or more strap faces of the position securing strap. The one or more light sources may be positioned along the one or more strap faces of the position securing strap. The one or more hydrocarbon sensors may be communicatively coupled to the one or more light sources such that the one or more light source illuminate in response to a sensor measurement of the one or more hydrocarbon sensors.

In one or more other aspects of the present disclosure, a method of detecting a hydrocarbon leak may include securing a position securing strap of a hydrocarbon leak detecting device to a test site using a locking mechanism of the position securing strap, performing one or more sensor measurements using the one or more hydrocarbon sensors, and illuminating the one or more light sources based on the one or more sensor measurements of the one or more hydrocarbon sensors. One or more hydrocarbon sensors may be positioned along one or more strap faces of the position securing strap. One or more light sources may be positioned along the one or more strap faces of the position securing strap. The one or more hydrocarbon sensors may be communicatively coupled to the one or more light sources.

Additional features and advantages of the technology described in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a two-dimensional view of a hydrocarbon leak detecting device, according to one or more embodiments shown and described in this disclosure;

FIG. 2 schematically depicts a three-dimensional view of a hydrocarbon leak detecting device, according to one or more embodiments shown and described in this disclosure;

FIG. 3 schematically depicts a three-dimensional view of a hydrocarbon leak detecting device secured to a test site, according to one or more embodiments shown and described in this disclosure; and

FIG. 4 schematically depicts a detection system that includes a hydrocarbon leak detecting device, according to one or more embodiments shown and described in this disclosure.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

The present disclosure is directed to hydrocarbon leak detecting devices and methods of detecting hydrocarbon leaks. In particular, the present disclosure is directed to a hydrocarbon leak detecting device comprising a position securing strap, one or more hydrocarbon sensors, and one or more light sources.

The various hydrocarbon leak detecting devices and methods of the present disclosure for detecting hydrocarbon leaks may provide increased efficiency in identifying hydrocarbon leaks in hydrocarbon pipelines compared to conventional methods used for detecting hydrocarbon leaks in hydrocarbon pipelines. That is, the various hydrocarbon leak detecting devices and methods for detecting hydrocarbon leaks of the present disclosure may provide continuous monitoring at a set location on a hydrocarbon pipelines without the need for personnel physically inspecting the hydrocarbon pipelines. The hydrocarbon leak detecting devices and methods of the present disclosure for detecting hydrocarbon leaks may also allow for monitoring hydrocarbon pipelines for leaks during all hours of the day, even during night or other times of darkness.

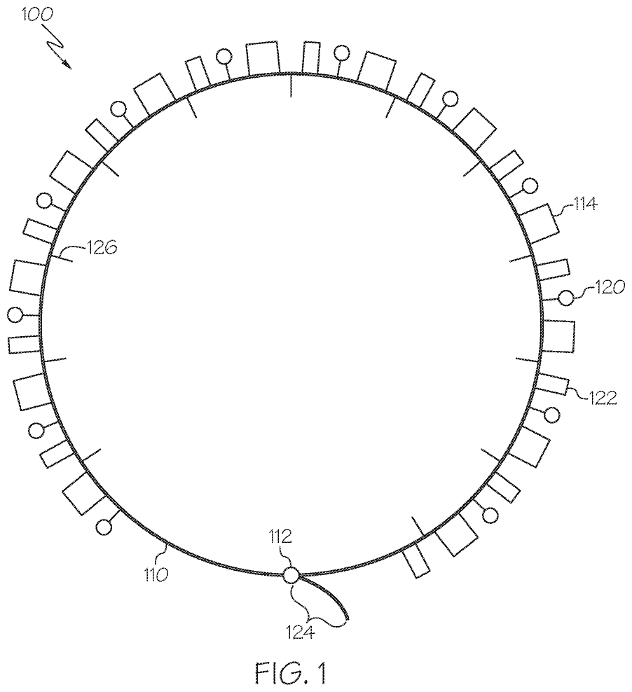

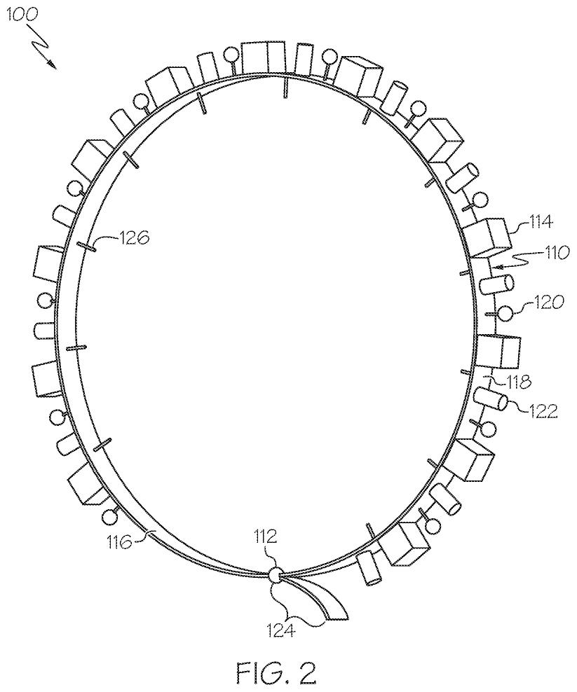

Referring initially to FIGS. 1-2, the hydrocarbon leak detecting device 100 comprises a position securing strap 110, one or more hydrocarbon sensors 114, and one or more light sources 120. The position securing strap 110 may comprise a locking mechanism 112 configured to secure the position securing strap 110 to a hydrocarbon test site. The one or more hydrocarbon sensors 114 positioned along one or more strap faces of the position securing strap 110 and one or more light sources 120 positioned along the one or more strap faces of the position securing strap 110. The one or more hydrocarbon sensors 114 may be communicatively coupled to the one or more light sources 120 such that the one or more light sources 120 may illuminate in response to a sensor measurement of the one or more hydrocarbon sensors 114.

The one or more hydrocarbon sensors 114 are operable to detect the presence of hydrocarbon fluids (both hydrocarbon liquids and gases). The hydrocarbon sensors 114 may be any conventional or yet to be developed sensor. For example, the hydrocarbon sensors 114 may be electrochemical sensors, catalytic bead (pellistor) sensors, photoionization detectors, infrared point sensors, infrared image sensors, semiconductor sensors, ultrasonic gas leak detectors, holographic gas sensors, or combinations of these. In embodiments, the hydrocarbon sensors 114 may be a VENTIS MX4 Multi-Gas Detector.

In some embodiments, the one or more hydrocarbon sensors 114 may be configured to measure the presence of an individual gas. In some embodiments, the one or more hydrocarbon sensors 114 may be configured to measure the presence of multiple different gases. That is, the one or more hydrocarbon sensors 114 comprise multi-gas monitors. In yet other embodiments, the one or more hydrocarbon sensors 114 may comprise a combination of sensors configured to measure the presence of an individual gas and sensors configured to measure the presence of multiple different gases.

The one or more light sources 120 may be any conventional or yet to be developed light source. For example, the light sources 120 may be incandescent, compact fluorescent (CFL), halogen, or light-emitting diodes. When the presence of a hydrocarbon leak is detected by the one or more hydrocarbon sensors 114, the one or more light sources 120 may illuminate such that the detection of a hydrocarbon leak is apparent all times of the day, both during day time and night time.

In embodiments where the hydrocarbon leak detecting device 100 comprises multiple light sources 120, all the light sources 120 may be illuminated if a hydrocarbon leak is detected. Alternatively, individual ones of the multiple light sources 120 may be illuminated such that the light sources 120 that are illuminated are closest to the hydrocarbon leak. Further, the light sources 120 may be configured to display an illumination pattern differently according to different hydrocarbon leak threat levels. For example, if a minor hydrocarbon leak is detected, the light sources 120 may illuminate solid or may illuminate as a blinking pattern. If a more substantial hydrocarbon leak is detected, the light sources 120 may illuminate solid or may illuminate as a blinking pattern, whichever may be the opposite of the illumination pattern for the minor hydrocarbon leak.

It is contemplated that the one or more light sources 120 may be replaced or complemented with one or more alarms. In environments where it may be difficult to see an illuminated light source 120, the alarm may provide additional or alternative notification of a detected hydrocarbon leak.

According to embodiments of the present disclosure, the one or more light sources 120 may illuminate in response to a sensor measurement of the one or more hydrocarbon sensors 114. The one or more light sources 120 may illuminate in response to a sensor measurement of the one or more hydrocarbon sensors 114 of the presence of one or more hydrocarbons. The one or more light sources 120 may illuminate when the presence of one or more hydrocarbons is detected during the one or more sensor measurements. For example, the one or more light sources 120 may illuminate in response to a sensor measurement of the one or more hydrocarbon sensors 114 above a set threshold of one or more hydrocarbons. In other embodiments, the one or more light sources 120 may illuminate when one or more hydrocarbons is are detected during the one or more sensor measurements at a level of 1 part per million (ppm) or greater of one or more hydrocarbons. For example, the one or more light sources 120 may illuminate when one or more hydrocarbons is are detected during the one or more sensor measurements at a level of 10 ppm or greater of one or more hydrocarbons, such as a level of 25 ppm or greater, 50 ppm or greater, 75 ppm or greater, 100 ppm or greater, 150 ppm or greater, 200 ppm or greater, or 250 ppm or greater of one or more hydrocarbons. In embodiments, the one or more light sources 120 may illuminate when one or more hydrocarbons is are detected during the one or more sensor measurements at a level of from 1 ppm to 999 ppm of one or more hydrocarbons, such as a level from 10 ppm to 999 ppm, from 50 ppm to 999 ppm, from 75 ppm to 999 ppm, from 100 ppm to 999 ppm, from 150 ppm to 999 ppm, from 200 ppm to 999 ppm, or from 250 ppm to 999 ppm of one or more hydrocarbons

According to embodiments, the position securing strap 110 of the hydrocarbon leak detecting device 100 may be any elongated flap or ribbon able to secure the various components of the hydrocarbon leak detecting device 100 to the test site. The position securing strap 110 may be any length, width, and thickness. In embodiments, the position securing strap 110 may be at least 3.0 meters (m), such as at least 3.5 m or 4.0 m. It is contemplated that the position securing strap 110 may be constructed from any material. In some embodiments, the position securing strap 110 may comprise a metallic material. For example, the position securing strap 110 may comprise carbon steel or any metallic alloy with elastic properties. In other embodiments, the position securing strap 110 may comprise a non-metallic material. For example, the position securing strap 110 may comprise acrylonitrile butadiene styrene (ABS) or any other thermoplastic polymer. In embodiments, the position securing strap 110 may comprise a combination of metallic and non-metallic materials.

The position securing strap 110 may comprise one or more strap faces. For example, the position securing strap 110 may comprise an inner face 116 and an outer face 118. When the position securing strap 110 is secured to a test site, the inner face 116 may be in contact with the test site and the outer face 118 may be opposite the inner face 116. The various components (e.g., the one or more hydrocarbon sensors 114, the one or more light sources 120, etc.) may be positioned along the outer face 118 of the position securing strap 110. It is contemplated that the position securing strap 110 may be porous, such that the various components may be able to detect hydrocarbon leaks at the test site through the pores of the position securing strap 110. In embodiments, the position securing strap 110 may have a plurality of holes extending from the outer face 118, through the position securing strap 110, to the inner face 116.

The locking mechanism 112 of the position securing strap 110 may be any mechanism that is able to secure the position securing strap 110. The locking mechanism 112 may provide tension to the position securing strap 110 around the test site such that the position securing strap 110 is relatively fixed to the test site. The locking mechanism 112 may secure the position securing strap 110 such that the size (e.g., diameter, circumference, length) of the position securing strap 110 may not be changed unless the locking mechanism 112 is disengaged. The locking mechanism 112 may be any mechanism able to engage the position securing strap 110 and maintain the location of the position securing strap 110. For example, the locking mechanism 112 may be a buckle, a tie down winch, a pinch down adjustable strap lock, a slide pinch clip, or a ratchet binder. One skilled in the art will appreciate that a variety of locking mechanisms 112 in addition to those listed here may also be used.

The position securing strap 110 may be adjustable, such that the hydrocarbon leak detecting device 100 may be secured to test sites of different sizes and is removable, such that the hydrocarbon leak detecting device 100 may be transferred between a plurality of test sites. That is, the position securing strap 110 may be able to be totally removed from the locking mechanism 112. More specifically, the position securing strap 110 may be removably engageable with the locking mechanism 112. In embodiments, the position securing strap 110 may comprise an adjustable length. The adjustable length may allow the position securing strap 110 to be adjustable. As test sites may be different sizes, the position securing strap 110 and locking mechanism 112 may, in conjunction, allow the hydrocarbon leak detecting device 100 to be secured to test sites of various sizes. In embodiments, a portion 124 of the position securing strap 110 may extend past the locking mechanism 112. The locking mechanism 112 may secure the position securing strap 110 with a portion 124 of the position securing strap 110 extending past the locking mechanism 112. As the test sites may be of various sizes, it is beneficial that the position securing strap 110 and locking mechanism 112 may be able to secure the hydrocarbon leak detecting device 100 to test sites of various sizes or geometries.

As a portion 124 of the position securing strap 110 may extend past the locking mechanism 112, it may be necessary to remove various components from the position securing strap 110 to allow the position securing strap 110 to extend past the locking mechanism 112. The hydrocarbon sensors 114, light sources 120, power sources 122, position securing pins 126, or combinations of these may be removable from the position securing strap 110. This facilitates connection to smaller test sites. It is contemplated that hydrocarbon sensors 114, light sources 120, power sources 122, and position securing pins 126 may be positioned on and connected to the position securing strap 110 in any number of ways. For example, hydrocarbon sensors 114, light sources 120, power sources 122, position securing pins 126 may connect to the position securing strap 110 using hook and loop fasteners, snap fasteners, or nuts and bolts. Additionally or alternatively, hydrocarbon sensors 114, light sources 120, power sources 122, position securing pins 126 may connect to the position securing strap 110 using an adjustable lock buckle or a strap slider adjustable mechanism.

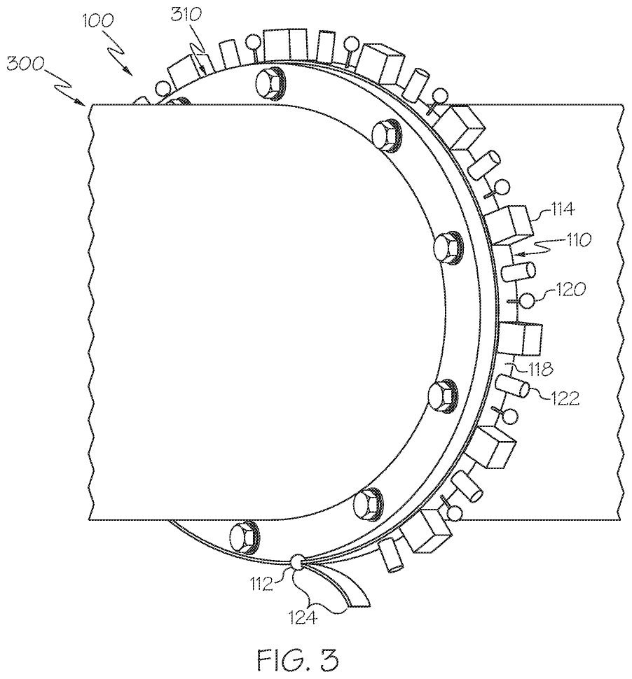

In operation, the hydrocarbon leak detecting device 100 may be positioned at any test site where it is desirable to monitor for the possibility of leaking hydrocarbons. Once hydrocarbons are extracted from a subsurface formation or reservoir, the hydrocarbons travel through numerous different pipes and pieces of equipment while being transferred and processed. As depicted in FIG. 3, the test site may comprise a hydrocarbon pipeline 300. Hydrocarbon pipelines may typically comprise numerous individual pipes coupled or fitted together. While the majority of the individual pipes may not be susceptible to leaks, the areas where individual pipes are attached to one another may be more susceptible to leaks. Therefore, the test site may comprise a hydrocarbon pipeline fitting. For example, as depicted in FIG. 3, the test site may comprise a hydrocarbon pipeline flange fitting 310.

As shown in FIG. 3, the hydrocarbon leak detecting device 100 may be positioned around a test site, where the test site is a hydrocarbon pipeline flange fitting 310. The hydrocarbon pipeline flange fitting 310 may refer to a plate or ring to form a rim at the end of a pipe when fastened to the pipe. Two hydrocarbon pipeline flange fittings 310 on two individual pieces of pipe may be joined together by bolts or a weld with a gasket between the two hydrocarbon pipeline flange fittings 310. As depicted in FIG. 3, the hydrocarbon leak detecting device 100 may be positioned to substantially monitor for hydrocarbon leaks at the hydrocarbon pipeline flange fitting 310. The hydrocarbon leak detecting device 100 may be positioned to measure leaks due to a faulty gasket or faulty hydrocarbon pipeline flange fitting 310. As one example, the hydrocarbon leak detecting device 100 may be positioned around a 48 inch hydrocarbon pipeline flange fitting 310.

The hydrocarbon leak detecting device 100 of may further comprise one or more power sources 122 positioned along the one or more strap faces of the position securing strap 110. The one or more power sources 122 may be communicatively coupled to the one or more hydrocarbon sensors 114, the one or more light sources 120, or both. The one or more hydrocarbon sensors 114, the one or more light sources 120, or both may receive power from the one or more power sources 122.

It is contemplated that various power sources 122 may be used with the hydrocarbon leak detecting device 100. According to one or more embodiments, the one or more power sources 122 may be one or more batteries. In embodiments, the one or more power sources 122 may be one or more solar panels.

Referring now to FIGS. 1-2, the hydrocarbon leak detecting device 100 may further comprise one or more position securing pins 126. The position securing pins 126 may be connected to and positioned along the inner face 116 of the position securing strap 110. The position securing pins 126 may ensure the position securing strap 110 stays in a fixed position at the test site. The position securing pins 126 may ensure the position securing strap 110 does not move along the test site. The position securing pins 126 may also ensure the position securing strap 110 does not rotate around the test site. The one or more position securing pins 126 may extend inward from the position securing strap 110. More specifically, the one or more position securing pins 126 may extend radially inward from the position securing strap 110. Depending on the test site, the position securing pins 126 may be any length. In embodiments, the one or more position securing pins 126 may comprise a length of from 1 millimeter (mm) to 100 mm, for example, from 2 mm to 50 mm, 5 mm to 25 mm, or the like, for example, 2 mm, 5 mm, 10 mm, 15 mm, 20 mm, 25 mm, 50 mm, 75 mm, or the like.

It is contemplated that the position securing pins 126 may be constructed of any material. The position securing pins 126 may be a metallic material or a non-metallic material. In some embodiments, the position securing pins 126 may be a plastic material or a rubber material. For example, the position securing pins 126 may be constructed carbon steel or any metallic alloy with elastic properties. Additionally or alternatively, the position securing pins 126 may be constructed from ABS.

As shown in FIGS. 1-3, the hydrocarbon leak detecting device 100 may comprise a plurality of hydrocarbon sensors 114, light sources 120, power sources 122, position securing pins 126, or combinations of these. While FIGS. 1-3 depict that the hydrocarbon leak detecting device 100 may comprise an equal amount of hydrocarbon sensors 114, light sources 120, power sources 122, this is not a requirement. It is contemplated that the hydrocarbon leak detecting device 100 may have any combination of hydrocarbon sensors 114, light sources 120, power sources 122, and position securing pins 126. For example, the hydrocarbon leak detecting device 100 may comprise twice as many hydrocarbon sensors 114 as light sources 120 or, alternatively, may comprise twice as many light sources 120 as hydrocarbon sensors 114.

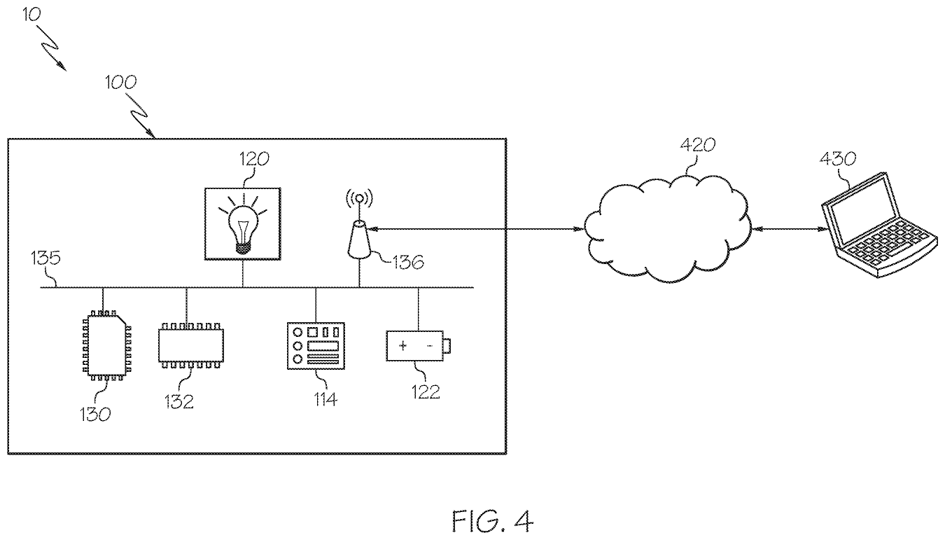

Referring again to FIG. 4, a detection system 10 may be provided for operating the hydrocarbon leak detecting device 100. The detection system 10 includes the one or more hydrocarbon sensors 114, the one or more light sources 120, and the one or more power sources 122, as well as a processor 130, a non-transitory electronic memory 132, and a communication path 135 that communicatively couples the plurality of components of the detection system 10.

In some embodiments, the processor 130 and the non-transitory electronic memory 132 and/or the other components are included within or on a single device, such as the position securing strap 110. In other embodiments, the processor 130 and the non-transitory electronic memory 132 and/or the other components may be distributed among multiple devices that are communicatively coupled. The non-transitory electronic memory 132 that stores a set of machine-readable instructions. The processor 130 executes the machine-readable instructions stored in the non-transitory electronic memory 132. The non-transitory electronic memory 132 may comprise RAM, ROM, flash memories, hard drives, or any device capable of storing machine-readable instructions such that the machine-readable instructions can be accessed by the processor 130. Accordingly, the detection system 10 described herein may be implemented in any conventional computer programming language, as pre-programmed hardware elements, or as a combination of hardware and software components. The non-transitory electronic memory 132 may be implemented as one memory module or a plurality of memory modules.

In some embodiments, the non-transitory electronic memory 132 includes instructions for executing the functions of the detection system 10. The instructions may include instructions for operating the hydrocarbon sensors 114 and light sources 120, for example, instructions regarding one or more hydrocarbons to detect, a light source operation routine (i.e., pattern, brightness, and duration of illumination), a hydrocarbon threshold level (i.e., a concentration level of hydrocarbon detection that triggers carious light source operation routines), or any other operational instructions.

In embodiments, the non-transitory electronic memory 132 may include instructions for the hydrocarbon sensors 114 to detect a specific hydrocarbon gas or a group of different hydrocarbons. The non-transitory electronic memory 132 may include instructions for the light sources 120 to illuminate differently depending the type of hydrocarbons detected or the concentration of the hydrocarbons detected. As previously described, if a minor hydrocarbon leak is detected, the non-transitory electronic memory 132 may include instruction for the light sources 120 to illuminate solid or as a blinking pattern. If a more substantial hydrocarbon leak is detected, the non-transitory electronic memory 132 may include instruction for the light sources 120 to illuminate solid or as a blinking pattern, whichever may be the opposite of the illumination pattern for the minor hydrocarbon leak. Additionally or alternatively, if a minor hydrocarbon leak is detected, the light sources 120 may not be illuminated at their full brightness. If a more substantial hydrocarbon leak is detected, the light sources 120 may be illuminated at their full brightness. It should be appreciated that any user-defined instructions may be programmed, even instructions different than those described herein.

The non-transitory electronic memory 132 may additionally or alternatively include instructions for the hydrocarbon sensors 114, the light sources 120, or both to detect, illuminate, or both depending on a concentration level of hydrocarbon detection.

The processor 130 may be any device capable of executing machine-readable instructions. For example, the processor 130 may be an integrated circuit, a microchip, a computer, or any other computing device. The non-transitory electronic memory 132 and the processor 130 are coupled to the communication path 135 that provides signal interconnectivity between various components and/or modules of the detection system 10. Accordingly, the communication path 135 may communicatively couple any number of processors with one another, and allow the modules coupled to the communication path 135 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like. As schematically depicted in FIG. 4, the communication path 135 communicatively couples the processor 130 and the non-transitory electronic memory 132 with a plurality of other components of the detection system 10.

The detection system 10 may also include network interface hardware 136 for communicatively coupling the detection system 10 to a portable device 430 via a network 420. The portable device 430 may include, without limitation, a laptop, a smartphone, a tablet, a personal media player, or any other electronic device that includes wireless communication functionality. The portable device 430 may be used to provide supplemental notification (in addition to the one or more light sources 120) of a detected hydrocarbon leak.

Referring now to FIGS. 1-4, a method of detecting a hydrocarbon leak may comprise securing a position securing strap 110 of a hydrocarbon leak detecting device 100 to a test site using a locking mechanism 112 of the position securing strap 110. As previously described, the hydrocarbon leak detecting device 100 may comprise one or more hydrocarbon sensors 114 that are positioned along one or more strap faces of the position securing strap 110 and one or more light sources 120 that are positioned along the one or more strap faces of the position securing strap 110. The one or more hydrocarbon sensors 114 may be communicatively coupled to the one or more light sources 120. The method may further comprise performing one or more sensor measurements using the one or more hydrocarbon sensors 114 at the test site. The one or more sensor measurements may measure a presence and amount of one or more hydrocarbons. The method may further comprise illuminating the one or more light sources 120 based on the one or more sensor measurements of the one or more hydrocarbon sensors 114. The hydrocarbon leak detecting device 100 may have any other features or properties previously described in the present disclosure for the hydrocarbon leak detecting device 100.

In embodiments, the method of detecting a hydrocarbon leak may be continuous. For example, while the hydrocarbon leak detecting device 100 is secured to a test site, the one or more hydrocarbon sensors 114 may be continuously monitoring for a hydrocarbon leak. In other embodiments, the method of detecting a hydrocarbon leak may be intermittent. For example, the one or more hydrocarbon sensors 114 or one or more light sources 120 may be activated or powered on only at specific times, such as, for example, during a predetermined leak test. More specifically, the one or more hydrocarbon sensors 114 or one or more light sources 120 may be activated or powered on when the test site is being monitored or tested for the presence of a hydrocarbon leak, but then deactivated or powered off once the leak test is complete.

In embodiments, the one or more sensor measurements may be performed continuously during a testing period. A testing period may refer to a time when the hydrocarbon leak detecting device 100 is secured to a test site and is performing sensor measurements using the one or more hydrocarbon sensors 114. In other embodiments, the one or more sensor measurements may be performed intermittently during a testing period.

While the present description and examples are provided in the context of detecting hydrocarbon leaks, it should be understood that systems and processes described in the present disclosure may be applicable for the detection of a wide variety of gases, including, but not limited to, carbon dioxide, nitrogen, hydrogen sulfide, helium, argon, or hydrogen.

One or more aspects of the present disclosure are described herein. A first aspect of the present disclosure may include a hydrocarbon leak detecting device, the hydrocarbon leak detecting device comprising a position securing strap comprising a locking mechanism configured to secure the position securing strap to a hydrocarbon test site; one or more hydrocarbon sensors positioned along one or more strap faces of the position securing strap; and one or more light sources positioned along the one or more strap faces of the position securing strap, wherein the one or more hydrocarbon sensors are communicatively coupled to the one or more light sources such that the one or more light source illuminate in response to a sensor measurement of the one or more hydrocarbon sensors.

A second aspect of the present disclosure may include the first aspect further comprising one or more power sources positioned along the one or more strap faces of the position securing strap, wherein the one or more power sources are communicatively coupled to the one or more hydrocarbon sensors, the one or more light sources, or both.

A third aspect of the present disclosure may include either the first or the second aspect, wherein: a portion of the position securing strap extends past the locking mechanism; and the locking mechanism secures the position securing strap with a length of the position securing strap extending past the locking mechanism.

A fourth aspect of the present disclosure may include any of the first through third aspects, wherein the position securing strap comprises a metallic material.

A fifth aspect of the present disclosure may include any of the first through fourth aspects, wherein the position securing strap comprises a non-metallic material.

A sixth aspect of the present disclosure may include any of the first through fifth aspects, wherein the one or more hydrocarbon sensors comprise multi-gas monitors.

A seventh aspect of the present disclosure may include any of the first through sixth aspects, wherein the one or more light sources comprise light-emitting diodes.

An eighth aspect of the present disclosure may include any of the second through seventh aspects, wherein the one or more power sources comprise one or more batteries.

A ninth aspect of the present disclosure may include any of the second through eighth aspects, wherein the one or more power sources comprise one or more solar panels.

A tenth aspect of the present disclosure may include any of the third through ninth aspects, wherein the position securing strap comprises an adjustable length.

An eleventh aspect of the present disclosure may include any of the first through tenth aspects, wherein the position securing strap is removably engageable with the locking mechanism.

A twelfth aspect of the present disclosure may include any of the first through eleventh aspects, further comprising one or more position securing pins positioned along an inner face of the position securing strap.

A thirteenth aspect of the present disclosure may include the twelfth aspect, wherein the one or more position securing pins extend radially inward from the position securing strap.

A fourteenth aspect of the present disclosure may include the twelfth aspect, wherein the one or more position securing pins comprise a length of from 1 millimeter to 100 millimeters.

A fifteenth aspect may include a method of detecting a hydrocarbon leak, the method comprising: securing a position securing strap of a hydrocarbon leak detecting device to a test site using a locking mechanism of the position securing strap, wherein: one or more hydrocarbon sensors are positioned along one or more strap faces of the position securing strap; one or more light sources are positioned along the one or more strap faces of the position securing strap; and the one or more hydrocarbon sensors are communicatively coupled to the one or more light sources; performing one or more sensor measurements using the one or more hydrocarbon sensors, wherein the one or more sensor measurements measure a presence of one or more hydrocarbons; and illuminating the one or more light sources based on one or more sensor measurements of the one or more hydrocarbon sensors.

A sixteenth aspect of the present disclosure may include the fifteenth aspect, wherein the test site comprises a hydrocarbon pipeline.

A seventeenth aspect of the present disclosure may include either the fifteenth or the sixteenth aspect, wherein the test site comprises a hydrocarbon pipeline flange fitting.

An eighteenth aspect of the present disclosure may include any of the fifteenth through seventeenth aspects, wherein the one or more light sources are illuminated when the presence of one or more hydrocarbons is detected during the one or more sensor measurements.

A nineteenth aspect of the present disclosure may include any of the fifteenth through eighteenth aspects, wherein the one or more light sources are illuminated when one or more hydrocarbons are detected during the one or more sensor measurements at a level of 1 ppm or greater of one or more hydrocarbons.

A twentieth aspect of the present disclosure may include any of the fifteenth through nineteenth aspects, wherein the one or more sensor measurements are performed continuously during a testing period.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

What is claimed is:

1. A hydrocarbon leak detecting device, the hydrocarbon leak detecting device comprising:
a position securing strap comprising a locking mechanism configured to secure the position securing strap to a test site;
one or more hydrocarbon sensors positioned along one or more strap faces of the position securing strap; and
one or more light sources positioned along the one or more strap faces of the position securing strap, wherein the one or more hydrocarbon sensors are communicatively coupled to the one or more light sources such that the one or more light sources illuminate in response to a sensor measurement of the one or more hydrocarbon sensors.

2. The hydrocarbon leak detecting device of claim 1, further comprising one or more power sources positioned along the one or more strap faces of the position securing strap, wherein the one or more power sources are communicatively coupled to the one or more hydrocarbon sensors, the one or more light sources, or both.

3. The hydrocarbon leak detecting device of claim 1, wherein:
a portion of the position securing strap extends past the locking mechanism; and
the locking mechanism secures the position securing strap with a length of the position securing strap extending past the locking mechanism.

4. The hydrocarbon leak detecting device of claim 1, wherein the position securing strap comprises a metallic material.

5. The hydrocarbon leak detecting device of claim 1, wherein the position securing strap comprises a non-metallic material.

6. The hydrocarbon leak detecting device of claim 1, wherein the one or more hydrocarbon sensors comprise multi-gas monitors.

7. The hydrocarbon leak detecting device of claim 1, wherein the one or more light sources comprise light-emitting diodes.

8. The hydrocarbon leak detecting device of claim 2, wherein the one or more power sources comprise one or more batteries.

9. The hydrocarbon leak detecting device of claim 2, wherein the one or more power sources comprise one or more solar panels.

10. The hydrocarbon leak detecting device of claim 3, wherein the position securing strap comprises an adjustable length.

11. The hydrocarbon leak detecting device of claim 1, wherein the position securing strap is removably engageable with the locking mechanism.

12. The hydrocarbon leak detecting device of claim 1, further comprising one or more position securing pins positioned along an inner face of the position securing strap.

13. The hydrocarbon leak detecting device of claim 12, wherein the one or more position securing pins extend radially inward from the position securing strap.

14. The hydrocarbon leak detecting device of claim 12, wherein the one or more position securing pins comprise a length of from 1 millimeter to 100 millimeters.

15. A method of detecting a hydrocarbon leak, the method comprising:
securing a position securing strap of a hydrocarbon leak detecting device to a test site using a locking mechanism of the position securing strap, wherein:
one or more hydrocarbon sensors are positioned along one or more strap faces of the position securing strap;
one or more light sources are positioned along the one or more strap faces of the position securing strap; and
the one or more hydrocarbon sensors are communicatively coupled to the one or more light sources;
performing one or more sensor measurements using the one or more hydrocarbon sensors, wherein the one or more sensor measurements measure a presence of one or more hydrocarbons; and
illuminating the one or more light sources based on one or more sensor measurements of the one or more hydrocarbon sensors.

16. The method of claim 15, wherein the test site comprises a hydrocarbon pipeline.

17. The method of claim 15, wherein the test site comprises a hydrocarbon pipeline flange fitting.

18. The method of claim 15, wherein the one or more light sources are illuminated when the presence of one or more hydrocarbons is detected during the one or more sensor measurements.

19. The method of claim 15, wherein the one or more light sources are illuminated when one or more hydrocarbons are detected during the one or more sensor measurements at a level of 1 ppm or greater of one or more hydrocarbons.

20. The method of claim 15, wherein the one or more sensor measurements are performed continuously during a testing period.
